(19) United States
(12) Patent Application Publication
(10) Pub. No.: US 2012/0117546 A1
(43) Pub. Date: May 10, 2012

(54) Run-time Module Interdependency Verification

(75) Inventors: Eli M. Dow, Poughkeepsie, NY (US); Marie R. Laser, Poughkeepsie, NY (US); Jessie Yu, Wappingers Falls, NY (US)

(73) Assignee: International Business Machines Corporation, Armonk, NY (US)

(21) Appl. No.: 12/941,247

(22) Filed: Nov. 8, 2010

(51) Int. Cl. G06F 9/44

(52) U.S. Cl. 717/128

(57) ABSTRACT

A method for determining intermodule dependency in software having a plurality of modules, at least a portion of the modules, executing calls to other modules, comprising loading the software modules into a memory, preferably in a contiguous extent, with the modules being logically separated; executing instructions of the software step-by-step with threading disabled; determining whether when an instruction is executed, a module other than the current modules is being called; and if a module other than the current module is being called, storing data sufficient to identify the calling instruction, the calling module, the called instruction and the called module. A computer readable medium, to which a processor of a system is operatively coupled, having executable instructions stored thereon for executing the method on a computer. A computer programmed to execute the method.

### BACKGROUND

Aspects of the present invention are directed to a system and a method for determining interdependency of software modules.

Modern enterprise systems are employed by large entities, such as corporations and universities, small entities and individuals for computing services. In that way, the enterprise systems are formed of significant hardware resources and software, including an operating system, installed on the hardware. The hardware and software are then accessed and used by individuals on their own or within the entities for their computing needs.

Developers often need to make changes to a piece of code that requires other pieces to be re-compiled (e.g. a macro update or a change in the programming interface). In some situation, a simple update to a commonly used macro would require hundreds of modules to be recompiled. Identifying all the parts being impacted is often a time consuming and tedious task, especially if the macro is nested in another macro. For example, if module M calls macro A, which in terms calls macro B (which could be in module M or another module N), then it becomes non-trivial that module M needs to be recompiled when macro B is updated.

One solution to solve this problem is to recompile everything. It is impractical, however, when there are too many potential candidates and would only waste resources (time, power, CPU cycle, etc). It is also often desired to avoid unnecessary recompiles to avoid potential compiler-introduced errors.

The same problem arises when a product is about to be shipped and the developers try to determine the minimum set of modules that need to be recompiled. A similar situation arises when a service representative attempts to determine which new update will cause the customer's application to no longer operate properly.

### SUMMARY

The inventors herein have discovered that a directed graph (or some type of chart/data structure showing the module dependencies would greatly reduce the time needed to identify all the modules impacted by a macro update. The information about module dependencies can be stored in many different data structures or charts (e.g. tables, directed acyclic graph, etc). The process includes monitoring access of data/instruction at the module level at run time. Extra-modular instruction/data accesses may be logged at run-time, thus providing a real picture of the module relationships and dependencies. Thus, module interdependency verification is based on run-time invalid module instruction and data access monitoring.

A computer system is operated under a synchronization scheme where threading is temporarily disabled. This in effect yields something somewhat analogous to, but markedly different from, what is experienced when doing single step execution in a debugger. Additionally it is preferable that each module is loaded into a contiguous extent. The modules or extents are in turn separated logically by module.

At each instruction cycle, instructions or data will be dealt with. In order to prevent access to another module, hardware protection bits are set if the hardware supports that feature on all other system modules. When exiting a module because of a branch style instruction, the protection bits are reset such that only the new module has them disabled while all other modules (including the caller) have their protection bit enabled in order to get a protection fault. The operating system, noticing the fault, writes the necessary information (described below) to a buffer, such as a local buffer, which may be organized during the machine idle time, immediately, or at some other convenient time.

Should an instruction occur, the software will ensure the previous instruction came from the same module as the current instruction or entered the current module via an appropriate entry point method construct. If the previous instruction was from another module, then that previous instructions address/module-name pair is logged in conjunction with the current instruction address/module-name pair forming a 4-tuple of caller callees.

In the case of data, each address to be fetched will be examined to ensure that it is from the same module as the instructions or from some other module. In a similar fashion, extra-modular accesses are logged with the data address/module-name pair of the data, along with the module-name/address of the instruction acting on that data. These pairs are associated into 4-tuple of operands, and data. The frequency of the calls can also be logged as it is sometimes useful to diagnose certain type of errors. An explicit white list may be created for a particular module. If module A is on module B's white list, then any extra-modular accesses from module A to module B will not be logged. Optimization may be taken such that instructions which will be contiguously executed (i.e. a segment of a page or contiguous pages of known length “n” instructions, with no branch instructions, and which operate only on local module data) may be executed without inspection. This is done by deactivating the examination routines for n cycles.

This infrastructure is generally applicable as it is a software only implementation of this functionality and may thus be ported to many operating systems or platforms. It should be noted by someone skilled in the art that certain hardware features may speed up this process.

In accordance with an aspect of the invention, a method for determining intermodule dependency in software having a plurality of modules, at least a portion of the modules, executing calls to other modules, comprises loading the software modules into a memory, preferably in a contiguous extent, with the modules being logically separated; executing instructions of the software step-by-step with threading disabled; determining whether when an instruction is executed, a module other than the current modules is being called; and if a module other than the current module is being called, storing data sufficient to identify the calling instruction, the calling module, the called instruction and the called module.

In accordance with another aspect of the invention, a computer readable medium, to which a processor of a system is operatively coupled, has executable instructions stored thereon which, when executed, cause the processor to execute steps comprising loading software modules into a memory in a contiguous extent, with the modules being logically separated; executing instructions of the software modules step-by-step with threading disabled; determining whether when an instruction is executed, a module other than the current modules is being called; and if a module other than the current module is being called, storing data sufficient to identify the calling instruction, the calling module, the called instruction and the called module.

In accordance with yet another aspect of the invention, a computer is programmed to determine intermodule dependency in software having a plurality of modules, at least a portion of the modules, executing calls to other modules. The computer comprises a memory for loading the software modules in a contiguous extent, with the modules being logically separated; a processor for executing instructions of the software step-by-step with threading disabled; the processor determining whether when an instruction is executed, a module other than the current modules is being called; and if a module other than the current module is being called, the processor storing data sufficient to identify the calling instruction, the calling module, the called instruction and the called module.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a schematic illustration of a computing system in accordance with embodiments of the invention; and

FIG. 2 is a flow diagram illustrating a method of implementing an embodiment of the invention on the computing system of FIG. 1.

### DETAILED DESCRIPTION

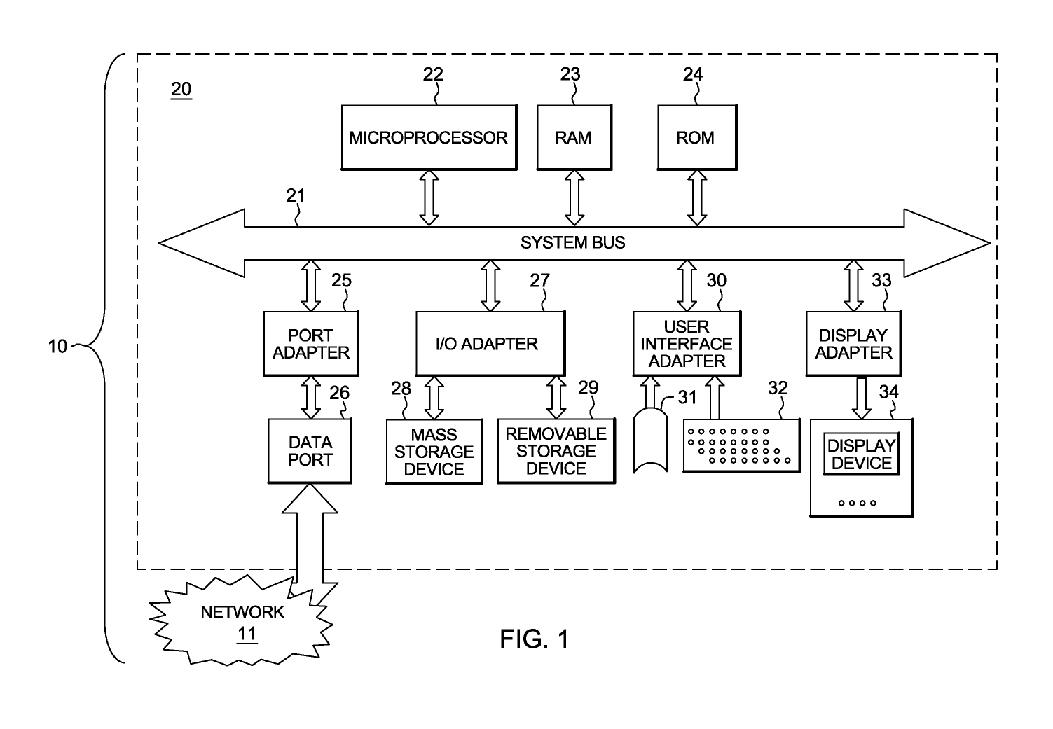

With reference to FIG. 1, a continuously operating computing system 10 is provided. The system 10 may include one or more computing devices 20 that communicate with each other via connections with a network 11. Where the system 10 includes a set of computing devices 20, such as where the system 10 is used by a corporate entity, the computing devices 20 may each operate in accordance with an enterprise class operating system (OS) which is widely distributed.

Each of the computing devices 20 includes multiple components and each of the multiple components has multiple functions. A system bus 21 is provided to allow each of the components to interact with others. A microprocessor 22 (i.e., a central processing unit) is provided to perform computing operations and calculations. Random Access Memory (RAM) 23 and Read-Only Memory (ROM) 24, along with additional types of memory, act as computer readable media and provide storage space for the storage of information and instructions for use by the microprocessor 22. A port adapter 25, to which a data port 26 is coupled, is also coupled to the system bus 21 and allows for the computing device 20 to communicate with the network 11. A mass storage device 28 and a removable storage device 29 provide additional storage space for information and are coupled to the system bus 21 by way of an input/output (I/O) adapter 27. User interface devices 31 and 32, such as a mouse and a keyboard, allow a user of the computing device 20 to issue commands and are coupled to the system bus 21 by way of the user interface adapter 30. Finally, a display device 34, which is coupled to the system bus 21 by way of the display adapter 33, allows for the display of information to the user.

In accordance with embodiments of the invention, the microprocessor 22 and the RAM 23 and the ROM 24, along with the other components described above, are associated with the computing device 20 and the system 10 as a whole. In that way, the microprocessor 22 and the RAM 23 and the ROM 24 are operatively coupled to one another as described above with the computer readable media having executable instructions stored thereon. These executable instructions, when executed, cause the microprocessor 22 to continuously load the operating system by continuously executing the operating system instructions. A compiler, serves to translate code of a source program, which is usually written in a programming language, into machine language code of a new module, which may be, for example, in some cases, a new version of an in-memory kernel module of the operating system. A loader, loads executable instructions into memory and isolates and interrupts current access to the in-memory module such that subsequent access is to the new module. Here, although reference is made to a compiler and a loader, respectively, it is understood that this is merely exemplary, and that functions normally associated with compilers may be undertaken by the loader and functions normally associated with loaders may be undertaken by the compiler.

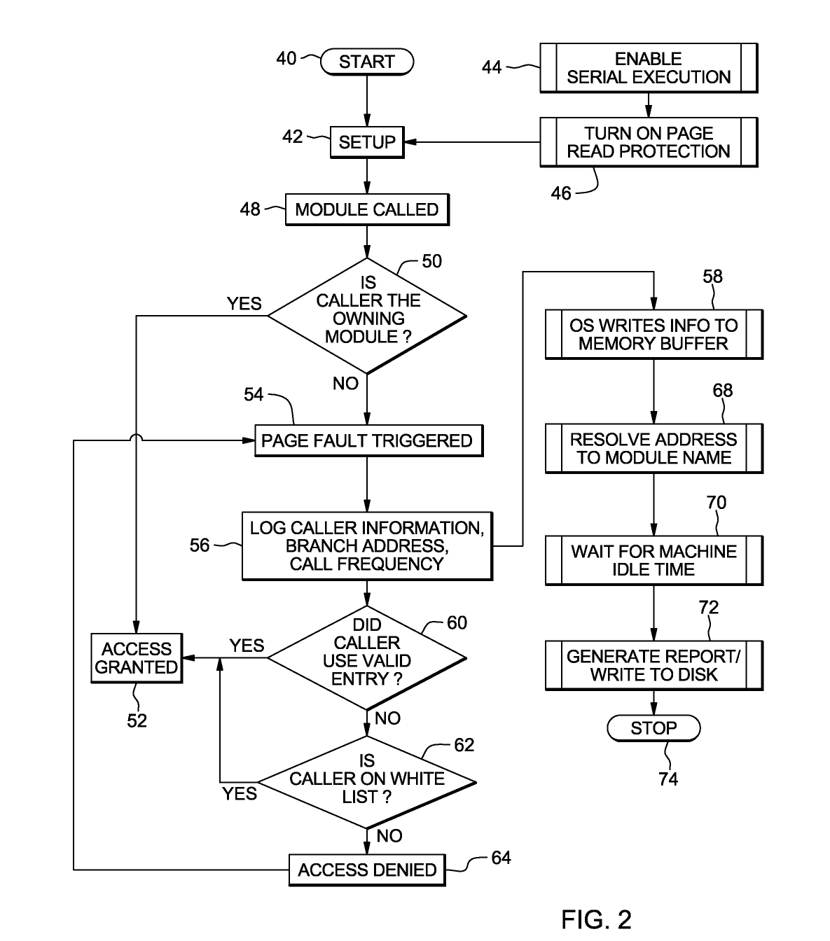

Referring to FIG. 2, the method is started at 40. Set up is accomplished at 42 as a result of the computer system of FIG. 1 being operated under a synchronization scheme where threading is temporarily disabled. Serial execution is enabled at 44. Each module is loaded into a contiguous extent. These extents are in turn separated logically by module. Page read protection is turned on at 46. In order to prevent access to another module, hardware protection bits are set if the hardware supports that feature on all other system modules.

At 48, a module is called during the step-by-step execution of instructions. At 50, a determination is made as to whether the calling modules, is the owning module. If the calling module is the owner, access to the module is granted at 52, step-by-step execution continues, and no page fault is triggered. By owning module it is meant a logical construct and software implementation of software object (compiled body of code) having authorized access to a given instruction. It can thus be said for any instruction, there must be at least one owning module and potentially several ancestor modules. Modules may be logically created based on relationship to source files or other means.

If an instruction is reached where the calling module is not the owner of the modules being called, a page fault is triggered at 54. For example, when exiting a module because of a branch style instruction, the protection bits are reset such that only the new module has them disabled while all other modules (including the caller) have their protection bit enabled in order to trigger the page fault at 54. The operating system, recognizing the fault logs certain information at 56, and writes the necessary information (described below) to a buffer at 58, such as a local buffer. For example, if the previous instruction was from another module, then that previous instructions address/module-name pair is logged in conjunction with the current instruction address/module-name pair forming a 4-tuple of caller callees.

Should an instruction occur, the software ensures that the previous instruction came from the same module as the current instruction (as described above) or entered the current module via an appropriate entry point method construct at 60. If the module was entered using a valid entry, then access is granted at 52, and step-by-step execution of instructions continues. If the module was entered using a valid entry, but the caller is NOT the owning module, then a page fault will be generated at 54.

In the case of data, each address to be fetched is examined to ensure that it is from the same module as the instructions or from some other module. In a similar fashion, extra-modular accesses are logged with the data address/module-name pair of the data, along with the module-name/address of the instruction acting on that data. These pairs4 are associated into 4-tuple of operands, and data. The frequency of the calls can also be logged as it is sometimes useful to diagnose certain type of errors.

An explicit white list may be created for a particular module, and this list is checked at 62. If module A is on module B's white list, then extra-modular accesses from module A to module B is granted at 52. If module A is not on module B's white list, then access is denied at 64, and any extra-modular accesses from module A to module B will be logged at 56, as described above, as a result of a page fault generated at 54. At the end of all instructions in the modules, all necessary data with respect to intermodule dependency has been accumulated.

At 68 the address of each instruction that generated a fault is resolved with respect to the module name. Data is accumulated while waiting for machine idle time at 70. At 72, during idle time, or at some other convenient time, the data may be organized, a report generated, and the information may be written to disk. The data may be stored in one of several relational databases, data structures or charts (e.g. tables, directed acyclic graph (DAG), etc.), for easy retrieval and manipulation of the data at a later time to assist in determining what the module interdependencies are, and which code will need to be recompiled as a result of upgrades and other changes. Preferably, for quick access, the data structure is a DAG wherein the nodes (points) are modules and the edge of the graph (a line connecting 2 points) indicates a dependent relationship. The directionality of the dependency is indicated by the directionality notation for the DAG. The program is concluded at 74.

Optimization may be taken such that instructions which will be contiguously executed (i.e. a segment of a page or contiguous pages of known length “n” instructions, with no branch instructions, and which operate only on local module data) may be executed without inspection. This is done by deactivating the examination routines described above for n cycles.

This infrastructure is generally applicable as it is a software only implementation of this functionality and may thus be ported to many operating systems or platforms. It should be noted by someone skilled in the art that certain hardware features, as described above, may speed up this process.

Variations described for the present embodiments can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present embodiments. In addition, the order of steps may be varied, and thus the amount of data stored may vary. For example, it is possible to rearrange the steps in the flow chart of FIG. 2 so that no data is ever stored if a calling modules is on the white list. This may be slightly more efficient in terms of less data stored, but may provide slightly less insight into the inter-operation of the modules when a change in programming has been made.

The present embodiments can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present embodiments can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the embodiments include an article of manufacture which comprises a computer usable medium having computer readable program code means embodied therein for causing a function described above. The computer readable program code means in the article of manufacture comprises computer readable program code means for causing a computer to effect the steps of a method of these embodiments.

Similarly, the present embodiments may be implemented as a computer program product comprising a computer usable medium having computer readable program code means embodied therein for causing a function described above. The computer readable program code means in the computer program product comprising computer readable program code means for causing a computer to effect one or more functions of these embodiments. Furthermore, the present invention may be implemented as a program storage device readable by machine, tangibly embodying a program of instructions executable by the machine to perform method steps for causing one or more functions of these embodiments.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method for determining intermodule dependency in software having a plurality of modules, at least a portion of said modules, executing calls to other modules, comprising:
loading the software modules into a memory, with the modules being logically separated;
executing instructions of the software step-by-step with threading disabled;
determining whether when an instruction is executed, a module other than the current modules is being called; and
if a module other than the current module is being called, storing data sufficient to identify the calling instruction, the calling module, the called instruction and the called module.

2. The method of claim 1, wherein when an instruction calls a different module, a page fault is generated.

3. The method of claim 1, wherein if an owning modules calls an owned module, no said data is stored.

4. The method of claim 1, wherein the software modules are loaded into memory in a contiguous extent.

5. The method of claim 1, further comprising establishing a white list of permissible calling instructions for a module.

6. The method of claim 1, further comprising:
determining when an instruction requires that data be fetched;
examining an address from which the data is to be fetched to determine whether it is associated with the module having that instruction; and
if the address is not associated with the module having that instruction, storing data sufficient to identify the data address and module-name associated with the data, and the module name and address of the instruction fetching that data.

7. The method of claim 1, further comprising storing data concerning frequency of calls from a first module to a second module.

8. The method of claim 1, further comprising contiguously executing a series of “n” instructions without determining whether, when an instruction is executed, a module other than the current modules is being called for a series of instructions within a module, when it is know that no branching to a different module occurs during said series of “n” instructions.

9. The method of claim 1, run on a computer having hardware protection bits, further comprising resetting the protection bits so that only a new module being called has the protection bits disabled while all other modules have their protection bits enabled in order to generate a protection fault.

10. A computer readable medium, to which a processor of a system is operatively coupled, having executable instructions stored thereon which, when executed, cause the processor to execute steps comprising:
loading software modules into a memory, with the modules being logically separated;
executing instructions of the software modules step-by-step with threading disabled;
determining whether when an instruction is executed, a module other than the current modules is being called; and
if a module other than the current module is being called, storing data sufficient to identify the calling instruction, the calling module, the called instruction and the called module.

11. The computer readable medium of claim 10, further comprising executable instructions stored thereon, so that when an instruction of one of said modules calls a different module, a page fault is generated.

12. The computer readable medium of claim 10, further comprising executable instructions stored thereon, so that if an owning modules calls an owned module, no said data is stored.

13. The method of claim 1, wherein the software modules are loaded into memory in a contiguous extent.

14. The computer readable medium of claim 10, further comprising executable instructions stored thereon, to facilitate establishing a white list of permissible calling instructions for a module.

15. The computer readable medium of claim 10, further comprising executable instructions stored thereon, to implement:
determining when an instruction requires that data be fetched;
examining an address from which the data is to be fetched to determine whether it is associated with the module having that instruction; and
if the address is not associated with the module having that instruction, storing data sufficient to identify the data address and module-name associated with the data, and the module name and address of the instruction fetching that data.

16. The computer readable medium of claim 10, further comprising executable instructions stored thereon, to facilitate storing data concerning frequency of calls from a first module to a second module.

17. The computer readable medium of claim 10, further comprising executable instructions stored thereon, to contiguously execute a series of “n” instructions without determining whether, when an instruction is executed, a module other than the current modules is being called for a series of instructions within a module, when it is know that no branching to a different module occurs during said series of “n” instructions.

18. A computer programmed to determine intermodule dependency in software having a plurality of modules, at least a portion of said modules, executing calls to other modules, comprising:
a memory for loading the software modules, with the modules being logically separated;
a processor for executing instructions of the software step-by-step with threading disabled;
the processor determining whether when an instruction is executed, a module other than the current modules is being called; and
if a module other than the current module is being called, the processor storing data sufficient to identify the calling instruction, the calling module, the called instruction and the called module.

19. The computer of claim 18, wherein when an instruction calls a different module, the processor generates a page fault.

20. The computer of claim 18, wherein the processor stores no said data if an owning modules calls an owned module.

21. The computer of claim 18, further comprising programming to facilitate establishing a white list of permissible calling instructions for a module.

22. The computer of claim 18, further programmed to:
determine when an instruction requires that data be fetched;
examine an address from which the data is to be fetched to determine whether it is associated with the module having that instruction; and
if the address is not associated with the module having that instruction, store data sufficient to identify the data address and module name associated with the data, and the module name and address of the instruction fetching that data.
